(19) United States
(12) Patent Application Publication
(10) Pub. No.: US 2011/0212823 A1
(43) Pub. Date: Sep. 1, 2011

(54) CERAMIC SHAPED BODY AND WIRING BOARD

(75) Inventors: Kentaro TANABE, Chino (JP); Atsushi DENDA, Chino (JP); Toshiyuki KOBAYASHI, Chino (JP); Yoshikazu HAMA, Okaya (JP); Naoyuki TOYODA, Suwa (JP)

(73) Assignee: SEIKO EPSON CORPORATION, Tokyo (JP)

(21) Appl. No.: 13/035,042

(22) Filed: Feb. 25, 2011

(30) Foreign Application Priority Data
Mar. 1, 2010 (JP) 2010-044742

(51) Int. Cl. C04B 35/00

(52) U.S. Cl. 501/1

(57) ABSTRACT

A ceramic shaped body for producing a wiring board includes a ceramic material, a binder, and a polyalcohol, the polyalcohol being present in at least a near-surface region of the ceramic shaped body.

### BACKGROUND

1. Technical Field

The present invention relates to a ceramic shaped body and a wiring board.

2. Related Art

As circuit boards (wiring boards) on which electronic components are mounted, ceramic circuit boards are widely used. A ceramic circuit board includes wires of a metallic material formed on a substrate made of ceramic (ceramic substrate). In such a ceramic circuit board, the substrate (ceramic substrate) itself is made of a multifunctional material, and this thus offers advantages for the formation of multi-layered interior parts and also in terms of dimension stability, for example.

Such a ceramic circuit board is produced as follows. Onto a ceramic shaped body made of a material containing ceramic particles and a binder, a composition containing metal particles is applied in a pattern corresponding to a desired wiring pattern (conductor pattern), and then the ceramic shaped body having applied thereto the composition is degreased and sintered.

As a method for forming a pattern on a ceramic shaped body, screen printing is widely used. Meanwhile, in recent years, there are demands for finer wiring (e.g., wires with a line width of 60 μm or less) and narrower pitches to achieve higher-density circuit boards. However, screen printing is disadvantageous for achieving finer wiring and narrower pitches, and it is difficult to meet such requirements.

Therefore, in recent years, as a method of forming a pattern on a ceramic shaped body, a droplet ejection method, in which droplets of a liquid material containing metal particles (conductor-pattern-forming ink) are ejected from a liquid ejection head, so-called ink-jet method, has been proposed (see, e.g., JP-A-2007-84387).

However, in the case where a pattern is formed on a ceramic shaped body using an ink, it often happens that the wires are crushed by atmospheric pressure upon the opening of a package that encloses the ceramic shaped bodies that have been stacked in a stacking step or by pressing, and such a wire is deformed to have a reduced thickness and an increased width. As a result, a short circuit is likely to occur between adjacent wires, and also, the line width is likely to deviate from the designed value. This leads to a problem in that the resulting circuit board (wiring board) has reduced reliability. There also is a problem in that the deformation of wires is accompanied by a decrease in the strength thereof, and continuity failure is thus often caused by cracking in the pattern, burning out due to the evaporation or sublimation of metal particles, etc.

### SUMMARY

An advantage of some aspects of the invention is to provide a reliable wiring board including a reliable conductor pattern that is less likely to crack, break, short-circuit, etc., and has a stable line width; and a ceramic shaped body suitable for use in the production of the wiring board.

A ceramic shaped body according to an aspect of the invention is a ceramic shaped body for producing a wiring board. The ceramic shaped body includes a ceramic material, a binder, and a polyalcohol, the polyalcohol being present in at least a near-surface region of the ceramic shaped body.

This makes it possible to provide a ceramic shaped body suitable for use in the production of a reliable wiring board including a reliable conductor pattern that is less likely to crack, break, short-circuit, etc., and has a stable line width.

It is preferable that the ceramic shaped body is obtained by shaping a composition containing the ceramic material, the binder, and the polyalcohol.

As a result, the productivity of the wiring board can be particularly improved.

It is preferable that the ceramic shaped body is obtained by applying a composition containing the polyalcohol to a temporary shaped body obtained by shaping a composition containing the ceramic material and the binder.

This allows the polyalcohol to penetrate into the ceramic shaped body and absorb excess solvent in a conductor-pattern-forming ink. A sea result, wet spreading, for example, can be suppressed. At the same time, on the ceramic shaped body, the solid content of the conductor-pattern-forming ink is increased, and the ink thus becomes harder, whereby the crushing of wires by pressing can be suppressed.

It is preferable that the polyalcohol is selectively present only in a near-surface region of the ceramic shaped body.

This allows the polyalcohol to penetrate into the ceramic shaped body and absorb excess solvent in a conductor-pattern-forming ink. As a result, wet spreading, for example, can be suppressed. At the same time, on the ceramic shaped body, the solid content of the conductor-pattern-forming ink is increased, and the ink thus becomes harder, whereby the crushing of wires by pressing can be suppressed.

It is preferable that the polyalcohol is 1,3-propanediol.

As a result, the reliability of the produced wiring board (formed conductor pattern) can be improved.

It is preferable that the binder is polyvinyl butyral.

As a result, the reliability of the produced wiring board (formed conductor pattern) can be improved.

A wiring board according to another aspect of the invention is obtained using a ceramic shaped body according to the aspect of the invention.

This makes it possible to provide a reliable wiring board including a reliable conductor pattern that is less likely to crack, break, short-circuit, etc., and has a stable line width.

It is preferable that the wiring board is obtained using a conductor-pattern-forming ink containing a polyglycerin compound.

As a result, the reliability of the produced wiring board (formed conductor pattern) can be improved.

It is preferable that the wiring board is obtained using a conductor-pattern-forming ink containing an aqueous dispersion medium.

As a result, the reliability of the produced wiring board (formed conductor pattern) can be improved.

### BRIEF DESCRIPTION OF THE DRAWINGS

The invention will be described with reference to the accompanying drawings, wherein like numbers reference like elements.

FIG. 1 shows a cross-sectional view of a ceramic shaped body according to a first embodiment of the invention.

FIG. 2 shows cross-sectional views illustrating a preferred embodiment of a method for producing a wiring board (ceramic circuit board) using a ceramic shaped body according to the first embodiment.

FIG. 3 shows a perspective view of a general configuration of an ink-jet apparatus.

FIG. 4 shows a schematic diagram for explaining a general configuration of an ink-jet head.

FIG. 5 shows a cross-sectional view of a ceramic shaped body according to a second embodiment of the invention.

FIG. 6 shows cross-sectional views illustrating a preferred embodiment of a method for producing a ceramic shaped body according to the second embodiment and a preferred embodiment of a method for producing a wiring board (ceramic circuit board) using the ceramic shaped body.

### DESCRIPTION OF EXEMPLARY EMBODIMENTS

Preferred embodiments of the invention will be described in detail hereinafter.

### First Embodiment

### Ceramic Shaped Body

First, a ceramic shaped body according to a first embodiment of the invention will be described.

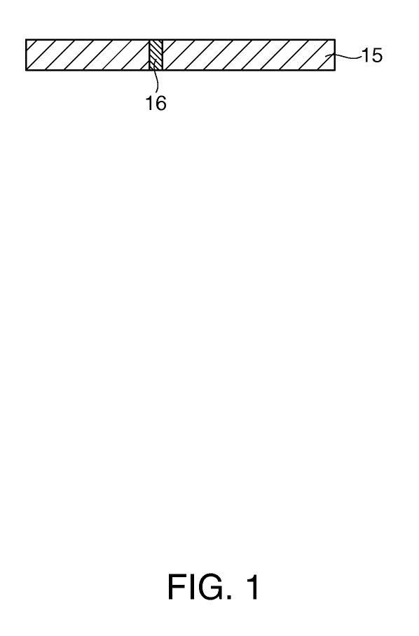

FIG. 1 shows a cross-sectional view of a ceramic shaped body according to the first embodiment.

A ceramic shaped body 15 is, after the application thereto of a conductor-pattern-forming ink containing metal particles, sintered for use in the production of a wiring board.

The ceramic shaped body (ceramic green sheet) 15 is made of a material containing a ceramic material, a binder, and a polyalcohol, and is in the form of a sheet. In particular, the ceramic shaped body (ceramic green sheet) 15 of this embodiment is obtained by shaping a composition containing the ceramic material, the binder, and the polyalcohol.

The ceramic shaped body 15 has formed therein a through hole. The through hole is filled with an electrically conductive material, providing an area to be used as a contact 33 (conductor post 16). The electrically conductive material for filling the through hole may be the below-mentioned conductor-pattern-forming ink, for example. In the configuration shown in the figure, the ceramic shaped body 15 has a through hole filled with an electrically conductive material. However, the filling with the electrically conductive material may also be performed, for example, in the precursor-forming step in the below-mentioned method for producing a wiring board.

As the ceramic material, a ceramic powder, such as alumina (Al₂O₃) or titanium oxide (TiO₂), is suitable.

The ceramic powder preferably has an average particle diameter of 1 μm or more and 2 μm or less.

In addition to the ceramic powder, it is preferable to use a glass powder as a starting powder. As a result, the characteristics of the sheet, such as thermal expansion coefficient, dielectric constant, and flexural strength, can be more suitably adjusted.

As the glass powder, borosilicate glass is suitable, for example.

The glass powder preferably has an average particle diameter of 1 μm or more and 2 μm or less.

The mixing ratio between ceramic powder and glass powder is preferably 2:1 to 1:2 on a weight basis.

As the binder, polyvinyl butyral is suitable. Polyvinyl butyral is insoluble in water and easily dissolves or swells in a so-called oily organic solvent. When polyvinyl butyral is used as the binder, the polyalcohol can be reliably held near the surface of the ceramic shaped body. Accordingly, the function of the polyalcohol described below in detail can be performed more effectively. As a result, the reliability of the wiring board produced using the ceramic shaped body (formed conductor pattern) can be improved.

The ceramic shaped body 15 includes a polyalcohol.

When the ceramic shaped body 15 includes a polyalcohol, in the method for producing a wiring board (conductor-pattern-precursor-forming step) described below in detail, from a conductor-pattern-forming ink 200 ejected onto the ceramic shaped body 15, a dispersion medium, a component of the conductor-pattern-forming ink, can be absorbed into the ceramic shaped body, thereby forming a layer of condensed metal particles (conductor pattern precursor 10) on the ceramic shaped body 15. As a result, with respect to metal particles contained in the conductor-pattern-forming ink 200 ejected onto the ceramic shaped body 15, the undesirable movement of such particles from the landing location can be effectively suppressed. At the same time, excess solvent in the conductor-pattern-forming ink is absorbed. Accordingly, the solid content of the conductor-pattern-forming ink is increased, and the ink thus becomes harder, whereby the crushing of wires by the application of pressure, such as pressing, can be suppressed. The final wiring board 30 can thus be provided as a reliable wiring board, including a conductor pattern 20 with a desired shape and a stable line width, in which cracking, breaking, short circuiting, etc., are reliably suppressed.

Further, because a dispersion medium, a component of the conductor-pattern-forming ink 200, can be absorbed into the ceramic shaped body 15 from the conductor-pattern-forming ink 200 ejected onto the ceramic shaped body 15, even when the conductor-pattern-forming ink 200 has a relatively high content of dispersion medium, with respect to metal particles contained in the conductor-pattern-forming ink 200 ejected onto the ceramic shaped body 15, the undesirable movement of the particles from the landing location can be reliably suppressed. Accordingly, the viscosity of the conductor-pattern-forming ink 200 to be ejected can be reduced, and the ejection stability of the conductor-pattern-forming ink 200 can thus be particularly improved. As a result, the productivity and yield of the wiring board 30 can be particularly improved.

In particular, because the ceramic shaped body 15 is obtained by shaping a composition containing the ceramic material, the binder, and the polyalcohol in this embodiment, the productivity of the wiring board 30 can be particularly improved.

The polyalcohol herein may be a compound containing two or more hydroxy groups in the molecule.

The polyalcohol preferably has a molecular weight of 62 or more and 200 or less, more preferably 62 or more and 106 or less, and still more preferably 62 or more and 92 or less.

Specific examples of polyalcohols include diethylene glycol, propylene glycol(1,2-propanediol), 1,3-propanediol, 1,3-butylene glycol, glycerin, condensates thereof (e.g., polyethylene glycol, polypropylene glycol, poly(1,3-propanediol), poly(1,3-butylene glycol), polyglycerin, etc.), and reduced polysaccharides such as erythritol, xylitol, and sorbitol, 1,3-Propanediol is particularly preferable. As a result, a dispersion medium, a component of the conductor-pattern-forming ink 200, can be moderately absorbed by the ceramic shaped body 15, and the reliability of the produced wiring board 30 (formed conductor pattern 20) can be improved.

When, as in this embodiment, the ceramic shaped body 15 is obtained by shaping a composition containing a ceramic material, a binder, and a polyalcohol, the content of polyalcohol in the ceramic shaped body 15 is preferably 1 wt % or more and 20 wt % or less, and more preferably 3 wt % or more and 15 wt % or less. When the content of polyalcohol is within such a range, the advantages mentioned above are more apparent.

### Method for Producing Wiring Board

Next, a method for producing a wiring board using the ceramic shaped body 15 will be described.

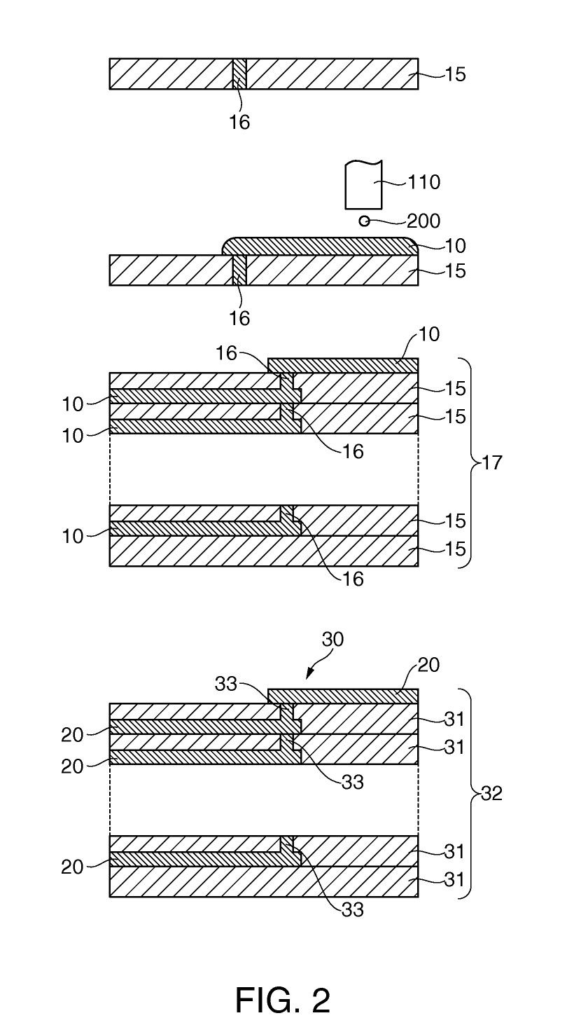

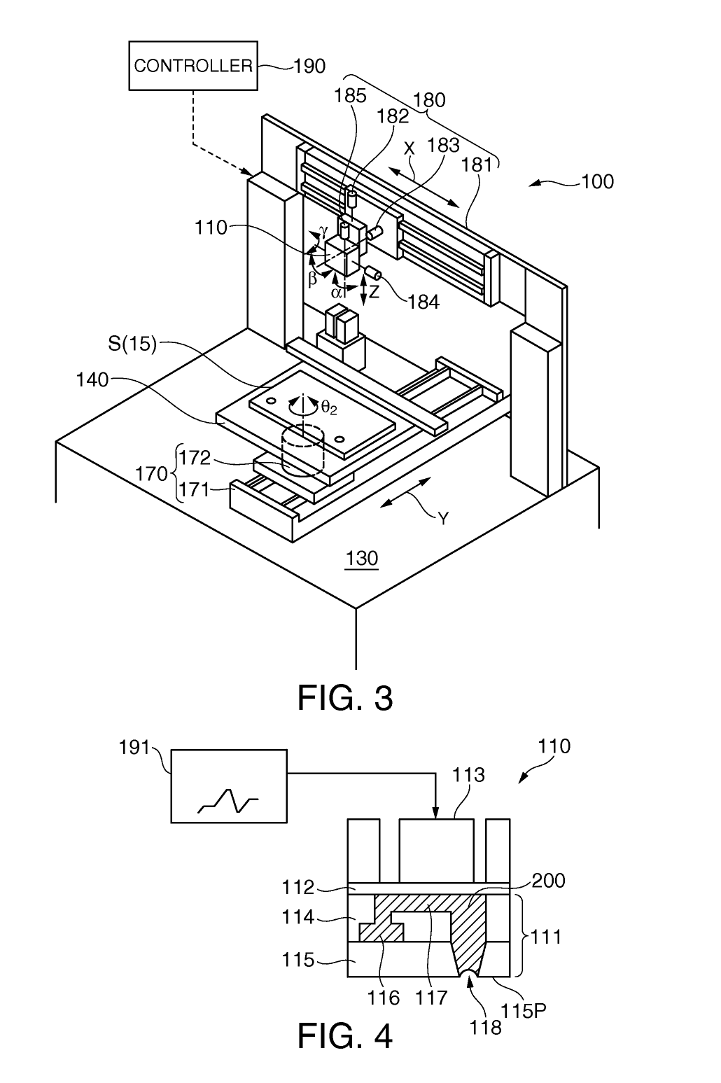

FIG. 2 shows cross-sectional views illustrating a preferred embodiment of a method for producing a wiring board (ceramic circuit board) using the ceramic shaped body. FIG. 3 shows a perspective view of a general configuration of an ink-jet apparatus (droplet ejection apparatus). FIG. 4 shows a schematic diagram for explaining a general configuration of an ink-jet head (droplet ejection head).

The method for producing a wiring board in this embodiment includes: preparing a plurality of sheet-like ceramic shaped bodies 15 made of a material containing a ceramic material, a binder, and a polyalcohol (ceramic-shaped-body-preparing step); ejecting a conductor-pattern-forming ink 200 including metal particles and a dispersion medium in which the metal particles are dispersed onto the surface of at least one of the ceramic shaped bodies 15 by a droplet ejection method, thereby forming a conductor pattern precursor 10 (conductor-pattern-precursor-forming step); stacking the plurality of ceramic shaped bodies 15 to give a laminate 17 (stacking step); and heating the laminate 17 to give a wiring board 30 including a conductor pattern 20 and ceramic substrates 31 (firing step).

### Ceramic-Shaped-Body-Preparing Step

In this step, a plurality of sheet-like ceramic shaped bodies (ceramic green sheets) 15 made of a material containing a ceramic material, a binder, and a polyalcohol, as mentioned above, are prepared.

Such a ceramic shaped body 15 can be obtained by mixing the above-mentioned starting powder with the binder and so forth, stirring the mixture into a slurry, and then shaping the slurry into a sheet.

When a ceramic shaped body (green sheet) 15 containing several kinds of powders is produced, it is preferable to previously mix the several kinds of powders prior to mixing with the binder and so forth.

In the preparation of a slurry, a plasticizer, an organic solvent (a substance that functions as a dispersion medium for dispersing the starting powder), a dispersant, and the like may be used.

In this embodiment, in the preparation of a slurry, the polyalcohol is mixed with the starting powder together with the binder and so forth, and stirred together.

The ceramic shaped body 15 can be suitably obtained, for example, by shaping the slurry into a sheet on a PET film using a doctor blade, a reverse coater, etc.

The ceramic shaped body 15 preferably has a thickness of not more than several micrometers and not less than several hundred micrometers.

The thus-obtained ceramic shaped body 15 in the form of a sheet is usually wound into a roll, cut according to the intended use of the product, then further cut into a sheet with a predetermined size, and used. In this embodiment, the ceramic shaped body 15 is cut into a 200 mm×200 mm square shape, for example.

Further, in this step, as required, a hole is made at a predetermined location by CO₂ laser drilling, YAG laser drilling, mechanical punching, etc., to give a through hole (through hole). The through hole is filled with an electrically conductive material, providing an area to be used as a contact 33 (conductor post 16).

### Conductor-Pattern-Precursor-Forming Step

Onto at least one surface of the thus-obtained ceramic green sheet (ceramic shaped body) 15, the conductor-pattern-forming ink (hereinafter sometimes referred to simply as “ink”) 200 described below in detail is applied by a droplet ejection (ink-jet) method, thereby forming the conductor pattern precursor 10 that is to be converted into a circuit 20. As a result, a ceramic shaped body 15 having a precursor 10 is obtained.

When the conductor pattern precursor 10 is sintered, the metal particles are fused together, whereby the conductor pattern precursor 10 forms the below-mentioned conductor pattern 20.

Hereinafter, the conductor-pattern-forming ink 200 used in this step will be described in detail.

### Conductor-Pattern-Forming Ink

The conductor-pattern-forming ink 200 is an ink used for the production of a conductor pattern precursor 10 by a droplet ejection method.

In this embodiment, as a typical example, a dispersion prepared by dispersing silver particles as metal particles in an aqueous dispersion medium is used as the conductor-pattern-forming ink 200.

Hereinafter, the components of the conductor-pattern-forming ink 200 will be described in detail.

### Aqueous Dispersion Medium

The conductor-pattern-forming ink 200 used in this embodiment contains an aqueous dispersion medium. When the conductor-pattern-forming ink 200 contains an aqueous dispersion medium as a dispersion medium, the dispersion medium can be more suitably absorbed into the ceramic shaped body 15 from the conductor-pattern-forming ink 200 ejected onto the ceramic shaped body 15. Accordingly, a layer of condensed metal particles (conductor pattern precursor 10) can be more suitably formed on the ceramic shaped body 15. As a result, the reliability of the produced wiring board 30 (formed conductor pattern 20) can be improved.

In the invention, an “aqueous dispersion medium” refers to a medium made of water and/or a liquid highly miscible with water (e.g., a liquid having a solubility of 30 g or more per 100 g of water at 25° C.). The aqueous dispersion medium thus includes water and/or a liquid highly miscible with water, and it is preferable that such an aqueous dispersion medium is mainly water. In particular, the water content thereof is preferably 70 wt % or more, and more preferably 90 wt % or more. As a result, the advantages mentioned above are more apparent.

Specific examples of aqueous dispersion media include water, alcoholic solvents such as methanol, ethanol, butanol, propanol, and isopropanol, ethereal solvents such as 1,4-dioxane and tetrahydrofuran (THF), aromatic-heterocyclic-compound-based solvents such as pyridine, pyrazine, and pyrrole, amide-based solvents such as N,N-dimethylformamide (DMF) and N,N-dimethylacetamide (DMA), nitrile-based solvents such as acetonitrile, and aldehyde-based solvents such as acetaldehyde. They may be used alone or in combination.

The content of aqueous dispersion medium in the conductor-pattern-forming ink 200 is preferably 25 wt % or more and 70 wt % or less, and more preferably 30 wt % or more and 60 wt % or less. As a result, while suitably adjusting the viscosity of the ink 200, changes in viscosity due to vaporization of the dispersion medium can be reduced.

### Silver Particles

Next, silver particles (metal particles) will be described.

Silver particles are a main component of a conductor pattern 20 to be formed, and are also a component for imparting electrical conductivity to the conductor pattern 20.

In the ink, the silver particles are in a dispersed state.

The silver particles preferably have an average particle diameter of 1 nm or more and 100 nm or less, and more preferably 10 nm or more and 30 nm or less. As a result, ink ejection stability can be further increased, while a fine conductor pattern can be easily formed. Unless otherwise noted, the term “average particle diameter” as used herein refers to the average particle diameter on a volume basis.

In the ink 200, the average interparticle distance between the silver particles is preferably 1.7 nm or more and 380 nm or less, and more preferably 1.75 nm or more and 300 nm or less. As a result, the viscosity of the conductor-pattern-forming ink 200 can be more optimized, and the ejection stability thereof can be particularly improved.

The content of silver particles (silver particles (metal particles) having no dispersant adsorbed on the surface thereof) in the ink 200 is preferably 0.5 wt % or more and 60 wt % or less, and more preferably 10 wt % or more and 45 wt % or less. As a result, breaking in the conductor pattern 20 can be more effectively suppressed, whereby the conductor pattern 20 can be more reliable.

It is preferable that the silver particles (metal particles) are dispersed in an aqueous dispersion medium as silver colloidal particles (metal colloidal particles) having a dispersant attached to the surface thereof. As a result, the dispersibility of the silver particles in the aqueous dispersion medium can be particularly improved, and the ejection stability of the ink 200 can be particularly improved.

The dispersant is preferably, but is not limited to, one containing a hydroxy acid or a salt thereof, in which the total number of COOH and OH groups is 3 or more, with the number of COOH groups being not less than the number of OH groups. Such a dispersant is adsorbed on the surface of the silver particles to form colloidal particles and, with the electrical force of repulsion between COOH groups in the dispersant, disperses the silver colloidal particles uniformly in an aqueous solution to stabilize the colloidal solution. Because of the presence of such silver colloidal particles stable in the ink 200, a fine conductor pattern 20 can be more easily formed. Further, in a pattern made of the ink 200 (precursor 10), the silver particles are uniformly distributed, making the pattern less likely to crack, break, etc. In contrast, when the total number of COOH and OH groups in the dispersant is less than 3 or the number of COOH groups is less than the number of OH groups, the sufficient dispersibility of the silver colloidal particles may not be obtained.

Examples of such dispersants include citric acid, malic acid, trisodium citrate, tripotassium citrate, trilithium citrate, triammonium citrate, disodium malate, tannic acid, gallotannic acid, and gallnut tannin. They may be used alone or in combination.

The dispersant may also contain a mercapto acid or a salt thereof, in which the total number of COOH and SH groups is 2 or more. In such a dispersant, a mercapto group is adsorbed on the surface of the silver particulates to form colloidal particles and, with the electrical force of repulsion between COOH groups in the dispersant, disperses the silver colloidal particles uniformly in an aqueous solution to stabilize the colloidal solution. Because of the presence of such silver colloidal particles stable in the ink 200, a fine conductor pattern 20 can be more easily formed. Further, in a pattern made of the ink 200 (precursor 10), the silver particles are uniformly distributed, making the pattern less likely to crack, break, etc. In contrast, when the total number of COOH and SH groups in the dispersant is less than 2, i.e., only either group is present, the sufficient dispersibility of the silver colloidal particles may not be obtained.

Examples of such dispersants include mercaptoacetic acid, mercaptopropionic acid, thiodipropionic acid, mercaptosuccinic acid, thioacetic acid, sodium mercaptoacetate, sodium mercaptopropionate, sodium thiodipropionate, disodium mercaptosuccinate, potassium mercaptoacetate, potassium mercaptopropionate, potassium thiodipropionate, and dipotassium mercaptosuccinate. They may be used alone or in combination.

The content of silver colloidal particles in the ink 200 is preferably 1 wt % or more and 60 wt % or less, and more preferably 5 wt % or more and 50 wt % or less. When the content of silver colloidal particles is less than the lower limit, the silver content is low. Accordingly, in the formation of a conductor pattern 20, when a relatively thick film is to be formed, several coats have to be applied. When the content of silver colloidal particles is more than the upper limit, the silver content is high, reducing dispersibility. Prevention of such a reduction requires an increased frequency of stirring.

The silver colloidal particles preferably have 1 wt % or more and 25 wt % or less weight loss upon heating up to 500° C. in a thermogravimetric analysis. When the colloidal particles (solid) are heated to 500° C., the dispersant attached to the surface thereof, the below-mentioned reducing agent (residual reducing agent), and the like undergo oxidative degradation, and most of them are gasified away. There is likely to be a slight amount of residual reducing agent, so the weight loss upon heating up to 500° C. will be nearly equivalent to the amount of dispersant in the silver colloidal particles. When the weight loss upon heating is less than 1 wt %, the amount of dispersant is small relative to the silver particles, and the sufficient dispersibility of the silver particles is reduced. When it is more than 25 wt %, the amount of residual dispersant is large relative to the silver particles, causing an increase in the specific resistance of a conductor pattern. However, the specific resistance can be ameliorated to some extent by, after the formation of the conductor pattern 20, heating and sintering the same to decompose and eliminate the organic matter. Therefore, this is effective for ceramic substrates or the like to be sintered at higher temperatures.

### Organic Binder

The conductor-pattern-forming ink 200 may contain an organic binder. An organic binder suppresses the aggregation of the silver particles in a conductor pattern precursor 10 formed using the conductor-pattern-forming ink 200. Specifically, in the formed conductor pattern precursor 10, an organic binder is present between the silver particles, thereby suppressing local cracking in the pattern due to the aggregation of the silver particles. Further, upon sintering, the organic binder can be decomposed and removed, and the silver particles in the conductor pattern precursor 10 are bonded together to form a conductor pattern 20.

Further, when the conductor-pattern-forming ink 200 contains an organic binder, the adhesion of the conductor pattern precursor 10 to the ceramic shaped body 15 (ceramic shaped body 15 including a polyalcohol) can be particularly improved. Accordingly, the leakage of the metal particles, which form the conductor pattern precursor 10, into undesirable regions can be more reliably suppressed. As a result, cracking, breaking, short-circuiting, etc., are more effectively suppressed, and a conductor pattern 20 can be formed more precisely. That is, the reliability of the resulting conductor pattern 20 can be particularly increased.

Examples of organic binders include, but are not limited to, polyethylene glycols such as polyethylene glycol #200 (weight-average molecular weight: 200), polyethylene glycol #300 (weight-average molecular weight: 300), polyethylene glycol #400 (average molecular weight: 400), polyethylene glycol #600 (weight-average molecular weight: 600), polyethylene glycol #1000 (weight-average molecular weight: 1000), polyethylene glycol #1500 (weight-average molecular weight: 1500), polyethylene glycol #1540 (weight-average molecular weight: 1540), and polyethylene glycol #2000 (weight-average molecular weight 2000); polyvinyl alcohols such as polyvinyl alcohol #200 (weight-average molecular weight: 200), polyvinyl alcohol #300 (weight-average molecular weight: 300), polyvinyl alcohol #400 (average molecular weight: 400), polyvinyl alcohol #600 (weight-average molecular weight: 600), polyvinyl alcohol #1000 (weight-average molecular weight: 1000), polyvinyl alcohol #1500 (weight-average molecular weight: 1500), polyvinyl alcohol #1540 (weight-average molecular weight: 1540), and polyvinyl alcohol #2000 (weight-average molecular weight: 2000); and polyglycerin compounds having a polyglycerin backbone, such as polyglycerin and polyglycerin esters. They may be used alone or in combination. Examples of polyglycerin esters include polyglycerin monostearate, tristearate, tetrastearate, monooleate, pentaoleate, monolaurate, monocaprylate, polyricinoleate, sesquistearate, decaoleate, and sesquioleate.

In particular, when a polyglycerin compound is used as the organic binder, the following advantages are achieved.

When a conductor pattern precursor 10 formed using the conductor-pattern-forming ink 200 is dried (removal of dispersion medium), a polyglycerin compound provides more suitable suppression of cracking in the conductor pattern precursor 10. The reasons for this are likely to be as follows. When the conductor-pattern-forming ink 200 contains a polyglycerin compound, polymer chains are present between the silver particles (metal particles), and thus the polyglycerin compound can suitably adjust the distances between the silver particles. Further, a polyglycerin compound has a relatively high boiling point. Therefore, the polyglycerin compound is not removed upon the removal of an aqueous dispersion medium, but is adhered around the silver particles. Accordingly, during the removal of an aqueous dispersion medium, the silver particles are enclosed in the polyglycerin compound for a long period of time, whereby a rapid contraction in volume due to the vaporization of the aqueous dispersion medium can be avoided, and also silver grain growth (aggregation) is hindered. As a result, cracking in the conductor pattern precursor 10 is suppressed.

In addition, upon sintering to form a conductor pattern 20, a polyglycerin compound provides more reliable suppression of breaking. The reasons for this are likely to be as follows. A polyglycerin compound has a relatively high boiling point or decomposition temperature. Therefore, in the process of forming a conductor pattern 20 from a conductor pattern precursor 10, after the evaporation of an aqueous dispersion medium, the polyglycerin compound does not evaporates or undergo thermal (oxidative) decomposition until relatively high temperatures, but remains in the conductor pattern precursor 10. Accordingly, until the polyglycerin compound evaporates or undergoes thermal (oxidative) decomposition, the polyglycerin compound is present around the silver particles, suppressing the close approach and aggregation of the silver particles. After the decomposition of the polyglycerin compound, the silver particles can be joined together more uniformly. Further, polymer chains (polyglycerin compound) are present between the silver particles (metal particles) in the pattern during sintering, and the polyglycerin compound thus maintains distances between the silver particles. The polyglycerin compound also has moderate flowability. Therefore, because of the presence of the polyglycerin compound, the conductor pattern precursor 10 is highly conformable to the expansion/shrinkage of the ceramic shaped body 15 due to temperature changes.

For the above reasons, presumably, breaking in the formed conductor pattern 20 can be more reliably suppressed.

When such a polyglycerin compound is present, the viscosity of the ink 200 can be more optimized, and the stability of ejection from an ink-jet head 110 can be improved more effectively. Further, film-forming properties can also be improved.

As the polyglycerin compound, of the above examples, polyglycerin is preferable. Polyglycerin is a component that is particularly conformable to the expansion/shrinkage of the ceramic shaped body 15 due to temperature changes, and, after the ceramic shaped body 15 is sintered, it can be more reliably removed from the conductor pattern 20. As a result, the electrical characteristics of the conductor pattern 20 can be further enhanced. Polyglycerin is also highly soluble in an aqueous dispersion medium, and thus is suitable.

The organic binder preferably has a weight-average molecular weight of 300 or more and 3000 or less, more preferably 400 or more and 1000 or less, and still more preferably 400 or more and 600 or less. As a result, during the drying of a pattern formed using the conductor-pattern-forming ink 200, cracking can be more reliably suppressed. In contrast, when the weight-average molecular weight of the organic binder is less than the lower limit, depending on the composition of the organic binder, the organic binder is likely to decompose during the removal of an aqueous dispersion medium. Accordingly, the crack-suppressing effect is reduced. When the weight-average molecular weight of the organic binder is more than the upper limit, depending on the composition of the organic binder, its solubility and dispersibility in the ink 200 may decrease due to the excluded volume effect, etc.

The content of organic binder in the ink 200 is preferably 1 wt % or more and 30 wt % or less, and more preferably 5 wt % or more and 20 wt % or less. As a result, while particularly improving the ejection stability of the ink 200, cracking and breaking can be more effectively suppressed. In contrast, when the content of organic binder is less than the lower limit, depending on the composition of the organic binder, the crack-suppressing effect maybe reduced. When the content of organic binder is more than the upper limit, depending on the composition of the organic binder, it may be difficult to sufficiently reduce the viscosity of the ink 200.

### Drying Retardant

The conductor-pattern-forming ink 200 may contain a drying retardant. A drying retardant suppresses the undesirable vaporization of an aqueous dispersion medium of the ink 200. As a result, the vaporization of an aqueous dispersion medium near the ejection orifice of an ink-jet apparatus can be suppressed, thereby reducing the viscosity increase or drying of the ink 200. Asa result of the presence of such a drying retardant in the conductor-pattern-forming ink 200, the droplet ejection stability of the ink 200 can be particularly improved. That is, weight variations in droplets of the ink 200 are reduced, thereby suppressing clogging, undesirable ejecting, etc. In particular, after loading the conductor-pattern-forming ink 200 into an ink-jet apparatus, even when the ink-jet apparatus has been left in standby for a long period of time (e.g., for 5 days) without operation, uniform amounts of the conductor-pattern-forming ink can be ejected precisely into the target location.

Examples of such drying retardants include compounds represented by the following formula (I), alkanolamines, sugar alcohols, etc., and they may be used alone or in combination:

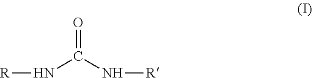

wherein R and R′ are each H or an alkyl group.

A compound represented by the formula (I) is a component with high hydrogen bonding ability. Therefore, such a compound has high affinity to water and is capable of retaining a moderate amount of moisture, and thus can suppress the undesirable vaporization of an aqueous dispersion medium of the conductor-pattern-forming ink 200.

Further, such a compound burns relatively easily, and thus can be more easily removed from the conductor-pattern-forming ink 200 (oxidative decomposition) in the formation of a conductor pattern 20.

In addition, in the case where the metal particles (silver particles) are colloidal particles having a dispersant attached to the surface thereof as mentioned above, such a compound binds to the dispersant on the surface through hydrogen bonds, thereby improving the dispersion stability of the metal particles. As a result, as well as ejection stability, the storage stability of the conductor-pattern-forming ink 200 is also improved.

As mentioned above, in a compound represented by the formula (I) used in the invention, R and R′ are each hydrogen or an alkyl group. It is preferable that R and R′ are both hydrogen. That is, the compound is preferably urea. As a result, the moisture-retaining properties can be particularly increased, achieving particularly excellent ejection stability. Further, when the metal particles are present as colloidal particles as mentioned above, particularly excellent dispersion stability is achieved.

The content of compound represented by the formula (I) in the ink is preferably 5 wt % or more and 25 wt % or less, more preferably 8 wt % or more and 20 wt % or less, and still more preferably 10 wt % or more and 18 wt % or less. As a result, the undesirable drying of the conductor-pattern-forming ink 200 can be more efficiently suppressed, and accordingly, the ejection stability of the ink 200 can be particularly improved.

An alkanolamine is a component with high moisture-retaining properties, and also is, in the case where the metal particles are colloidal particles as mentioned above, capable of activating functional groups of the dispersant on the surface of the colloidal particles. Accordingly, the dispersion stability of the metal particles can be further enhanced.

There are various kinds of alkanolamines, examples thereof including monoethanolamine, diethanolamine, triethanolamine, monopropanolamine, dipropanolamine, and tripropanolamine.

The alkanolamine is preferably a tertiary amine.. Of alkanolamines, a tertiary amine has particularly high moisture-retaining properties, and thus the advantages mentioned above are more apparent.

Of tertiary amines, triethanolamine is particularly preferable for its high handleability, moisture-retaining properties, etc.

The content of alkanolamine in the conductor-pattern-forming ink 200 is preferably 1 wt % or more and 10 wt % or less, and more preferably 3 wt % or more and 7 wt % or less. As a result, the ejection stability of the conductor-pattern-forming ink 200 can be improved more effectively.

A sugar alcohol is obtainable by reducing the aldehyde or ketone group of a saccharide.

A sugar alcohol is a compound with high moisture-retaining properties. A sugar alcohol also has a large number of oxygen atoms per molecular weight, and thus is easily decomposed and removed when the atmosphere reaches the decomposition temperature of the sugar alcohol. Therefore, in the formation of a conductor pattern 20, by setting the temperature of the conductor pattern precursor 10 higher than the decomposition temperature of the sugar alcohol, the sugar alcohol can be reliably removed from the resulting conductor pattern 20 (oxidative decomposition).

Examples of sugar alcohols include threitol, erythritol, pentaerythritol, dipentaerythritol, tripentaerythritol, arabitol, ribitol, xylitol, sorbitol, mannitol, threitol, gulitol, talitol, galactitol, allitol, altritol, dulcitol, iditol, glycerin (glycerol), inositol, maltitol, isomaltitol, lactitol, and turanitol. They may be used alone or in combination.

The content of sugar alcohol in the conductor-pattern-forming ink 200 is preferably 3 wt % or more and 20 wt % or less, and more preferably 5 wt % or more and 15 wt % or less. As a result, the vaporization of an aqueous dispersion medium of the conductor-pattern-forming ink 200 can be more reliably suppressed, and the conductor-pattern-forming ink 200 maintains particularly improved droplet ejection stability for a longer period of time.

### Surface Tension Adjuster

The conductor-pattern-forming ink 200 may also contain a surface tension adjuster.

A surface tension adjuster functions to adjust the contact angle between the conductor-pattern-forming ink 200 and the ceramic shaped body 15 to a predetermined angle.

Various surfactants are usable as surface tension adjusters, and they may be used alone or in combination. It is preferable that an acetylene-glycol-based compound is included.

An acetylene-glycol-based compound, even in a small amount, makes it possible to adjust the contact angle between the conductor-pattern-forming ink 200 and the ceramic shaped body 15 to be within a predetermined range. By adjusting the contact angle between the conductor-pattern-forming ink 200 and the ceramic shaped body 15 to be within a predetermined range, a finer conductor pattern 20 can be formed. Further, even when bubbles are incorporated into the ejected droplets, such bubbles can be quickly removed. As a result, cracking and breaking in the resulting conductor pattern 20 can be more effectively suppressed.

Examples of acetylene-glycol-based compounds include those of the Surfynol 104 series (104E, 104H, 104PG-50, 104PA, etc.), the Surfynol 400 series (420, 465, 485, etc.), and the Olfine series (EXP4036, EXP4001, E1010, etc.) (“Surfynol” and “Olfine” are trade names of NISSIN CHEMICAL INDUSTRY). They may be used alone or in combination.

The ink 200 preferably contains two or more kinds of acetylene-glycol-based compounds having different HLB values. The contact angle between the conductor-pattern-forming ink 200 and the ceramic shaped body 15 can be more easily adjusted to be within a predetermined range.

It is particularly preferable that of the two or more kinds of acetylene-glycol-based compounds contained in the ink 200, the acetylene-glycol-based compound with the highest HLB value and the acetylene-glycol-based compound with the lowest HLB value have an HLB value difference of 4 or more and 12 or less, and more preferably 5 or more and 10 or less. As a result, the contact angle between the conductor-pattern-forming ink 200 and the ceramic shaped body 15 can be more easily adjusted to be within a predetermined range using smaller amounts of acetylene-glycol-based compounds.

When the ink 200 contains two or more kinds of acetylene-glycol-based compounds, the acetylene-glycol-based compound with the highest HLB value preferably has an HLB value of 8 or more and 16 or less, and more preferably 9 or more and 14 or less.

Also, when the ink 200 contains two or more kinds of acetylene-glycol-based compounds, the acetylene-glycol-based compound with the lowest HLB value preferably has an HLB value of 2 or more and 7 or less, and more preferably 3 or more and 5 or less.

The content of surface tension adjuster in the ink 200 is preferably 0.001 wt % or more and 1 wt % or less, and more preferably 0.01 wt % or more and 0.5 wt % or less. As a result, the contact angle between the conductor-pattern-forming ink 200 and the ceramic shaped body 15 can be more effectively adjusted to be within a predetermined range.

### Other Components

The components of the conductor-pattern-forming ink 200 are not limited to the above components, and may also contain other components.

The viscosity of the conductor-pattern-forming ink 200 is not limited, and is preferably 1 mPa-s or more and 15 mPa-s or less, and more preferably 4 mPa-s or more and 11 mPa-s or less. As a result, droplet ejection stability can be improved. At the same time, the undesirable wet spreading of the ink 200 that has landed on the ceramic shaped body 15 can be more reliably suppressed. Accordingly, a conductor pattern precursor 10 with a fine line width can be formed.

In this embodiment, the conductor-pattern-forming ink 200 can be ejected, for example, using an ink-jet apparatus (droplet ejection apparatus) 100 as shown in FIGS. 3 and 4. Hereinafter, the ink-jet apparatus 100 and the ejection of droplets using the ink-jet apparatus 100 will be described.

FIG. 3 shows a perspective view of the ink-jet apparatus 100. In FIG. 3, the direction X, the direction Y, and the Z direction represent the horizontal direction, the anteroposterior direction, and the vertical direction of a base 130, respectively.

The ink-jet apparatus 100 includes an ink-jet head (droplet ejection head; hereinafter simply referred to as “head”) 110 as shown in FIG. 4, the base 130, a table 140, a controller 190, a table-positioning unit 170, and a head-positioning unit 180.

The base 130 is a support for the components of the droplet ejection apparatus 100, including the table 140, the table-positioning unit 170, the head-positioning unit 180, etc.

The table 140 is disposed via the table-positioning unit 170 on the base 130. A substrate S (in this embodiment, a ceramic green sheet 15) is placed on the table 140.

A rubber heater (not shown) is disposed on the back side of the table 140. The ceramic green sheet 15 is placed on the table 140 in such a manner that the entire top surface thereof is heated by the rubber heater to a predetermined temperature.

With respect to the ink 200 that has landed on the ceramic green sheet 15, as mentioned above, at least a part of an aqueous dispersion medium, a component of the ink 200, is absorbed by the ceramic shaped body 15, while at least a part of the aqueous dispersion medium evaporates from the surface of the ink 200. At this time, the ceramic green sheet 15 is being heated. Therefore, the evaporation of the aqueous dispersion medium is accelerated, and the content of aqueous dispersion medium in the layer of condensed metal particles (conductor pattern precursor 10) is effectively reduced.

The temperature of heating the ceramic green sheet 15 is preferably 40° C. or more and 100° C. or less, and more preferably 50° C. or more and 70° C. or less, for example. By employing such conditions, cracking upon the evaporation of the aqueous dispersion medium can be more effectively suppressed.

The table-positioning unit 170 includes a first moving unit 171 and a motor 172. The table-positioning unit 170 determines the position of the table 140 in relation to the base 130, and thereby determines the position of the ceramic green sheet 15 in relation to the base 130.

The first moving unit 171 includes two rails extending substantially parallel to the direction Y and a support base that moves on the rails. The support base of the first moving unit 171 supports the table 140 via the motor 172. By moving the support base on the rails, the table 140, on which the substrate S is placed, is moved and positioned in the direction Y.

The motor 172 supports the table 140. The motor 172 rocks and positions the table 140 in the direction θz.

The head-positioning unit 180 includes a second moving unit 181, a linear motor 182, and motors 183, 184, and 185. The head-positioning unit 180 determines the position of the head 110.

The second moving unit 181 includes two support posts standing proud of the base 130, a rail base that has two rails and is disposed between and supported by the support posts, and a support member (not shown) that is movable along the rails and supports the head 110. By moving the support member along the rails, the head 110 is moved and positioned in the direction X.

The linear motor 182 is disposed near the support member, and can move and position the head 110 in the direction Z.

The motors 183, 184, and 185 rock and position the head 110 in the directions α, β, and γ, respectively.

Owing to the table-positioning unit 170 and the head-positioning unit 180, the ink-jet apparatus 100 enables precise control of the position and posture of the substrate S on the table 140 relative to an ink ejection surface 115P of the head 110.

As shown in FIG. 4, the head 110 ejects the ink 200 from a nozzle (protrusion) 118 using an ink-jet technique (droplet ejection technique). This embodiment employs a piezoelectric technique, in which the head 110 ejects an ink using a piezo element 113 as a piezoelectric element. The piezoelectric technique does not apply heat to the ink 200, and thus is advantageous in that the composition of the material is not affected, etc.

The head 110 includes a head body 111, a diaphragm 112, and the piezo element 113.

The head body 111 includes a body 114 and a nozzle plate 115 on the lower end face of the body 114. The body 114 is sandwiched between the plate-like nozzle plate 115 and the diaphragm 112, creating a reservoir 116 as a space and a plurality of ink chambers 117 branched from the reservoir 116.

The ink 200 is supplied to the reservoir 116 from an ink tank (not shown). The reservoir 116 forms a channel for supplying the ink 200 to each ink chamber 117.

The nozzle plate 115 is disposed on the lower end face of the body 114 and forms the ink ejection surface 115P. The nozzle plate 115 has a plurality of nozzles 118 for ejecting the ink 200, which open into respective ink chambers 117. An ink channel is formed from each ink chamber 117 toward the corresponding nozzle 118.

The diaphragm 112 is disposed on the upper end face of the head body 111, and forms the wall of each ink chamber 117. The diaphragm 112 can vibrate in response to the vibration of the piezo element 113.

The piezo element 113 is provided corresponding to each ink chamber 117 and is disposed on the side of the diaphragm 112 opposite from the head body 111. The piezo element 113 includes a piezoelectric material, such as crystal, sandwiched between a pair of electrodes (not shown). The pair of the electrodes are connected to a drive circuit 191.

When an electrical signal is input from the drive circuit 191 to the piezo element 113, the piezo element 113 undergoes expansive deformation or contractive deformation. As a result of the contractive deformation of the piezo element 113, the pressure in the corresponding ink chamber 117 decreases, and the ink 200 flows into the ink chamber 117 from the reservoir 116. Meanwhile, as a result of the expansive deformation of the piezo element 113, the pressure in the corresponding ink chamber 117 increases, and the ink 200 is ejected from the nozzle 118. By changing the applied voltage, the amount of deformation of the piezo element 113 can be controlled. Further, by changing the frequency of the applied voltage, the rate of deformation of the piezo element 113 can be controlled. That is, by controlling the voltage applied to the piezo element 113, the conditions for the ejection of the ink 200 can be controlled.

The controller 190 controls each part of the ink-jet apparatus 100. For example, the waveform of the applied voltage produced in the drive circuit 191 is adjusted to control the conditions for the ejection of the ink 200, or the head-positioning unit 180 and the table-positioning unit 170 are controlled to control the ink 200 ejection location on the substrate S.

By using such an ink-jet apparatus 100, a desired amount of the ink 200 can be ejected precisely into a desired position on the ceramic green sheet 15 (substrate S). Further, because of the use of the ceramic shaped body (ceramic green sheet) 15 and the conductor-pattern-forming ink (ink) 200, with respect to the metal particles contained in the ink 200 ejected onto the ceramic green sheet 15, the undesirable movement of the particles from the landing location can be effectively suppressed. Accordingly, a conductor pattern precursor 10 with a desired shape can be reliably formed.

The formed conductor pattern precursor 10 may be further subjected to a drying treatment. The drying treatment can be performed under the same conditions as the temperature of heating the ceramic green sheet 15 during the droplet ejection.

The thickness of the conductor pattern precursor 10 can be adjusted by setting the conditions for the ejection of the ink 200 as follows. Specifically, when a thick part of the conductor pattern precursor 10 is to be formed, the amount of the ink 200 (or the number of droplets) ejected per area of the part is set large, while when a thin part of the conductor pattern precursor 10 is to be formed, the amount of the ink 200 (or the number of droplets) ejected per area of the part is set small.

As mentioned above, the ceramic green sheet (ceramic shaped body) 15 includes a polyalcohol. Therefore, from the ink (conductor-pattern-forming ink) 200 that has landed on the ceramic green sheet 15, an aqueous dispersion medium (dispersion medium), a component of the ink 200, is quickly absorbed by the ceramic green sheet 15. As a result, even when a relatively thick conductor pattern precursor 10 is to be formed, and a relatively large amount of the ink 200 is ejected into one area, the excessive wet spreading of the ink 200 can be suppressed, and a conductor pattern precursor 10 with a smaller line width can be more suitably formed.

In the case where the ink 200 after the evaporation of a dispersion medium contains a drying retardant, even when the formed precursor 10 has not completely dried, the washout of the pattern is suppressed. Therefore, it is possible to leave the applied and dried ink 200 to stand for a long period, and then apply additional ink 200 thereto.

Further, in the case where the ink 200 contains the organic binder, because such an organic binder (particularly a polyglycerin compound) is a chemically and physically stable compound, even when the applied and dried ink 200 is left to stand for a long period of time, the ink 200 is less likely to deteriorate, and additional ink 200 can be applied thereto. Accordingly, a more uniform pattern can be formed, and the precursor 10 itself is less likely to be multilayered. As a result, an increase in the specific resistance of the entire conductor pattern 20, which is caused by an increase in the specific resistance between layers, is less likely to occur.

By performing these steps, the conductor pattern 20 of this embodiment can be formed thicker as compared with a conductor pattern formed using a known ink. More specifically, a pattern with a thickness of 15 μm or more can be formed.

### Stacking Step

Next, the PET film is removed from the ceramic green sheet 15, and such ceramic green sheets are stacked to give a laminate 17.

At this time, the ceramic green sheets 15 are stacked in such a manner that the precursors 10 of the ceramic green sheets 15 arranged one above the other are connected to each other through the conductor post 16 as required.

Subsequently, the stacked ceramic green sheets 15 are packed and sealed in a polyethylene package. Then, while heating to a temperature higher than the glass transition temperature of the binder in the ceramic green sheets 15, the ceramic green sheets 15 are pressed together using a hydrostatic press. The laminate 17 is thus obtained.

### Firing Step

After the formation of the laminate 17, the laminate is removed from the polyethylene package, and then heat-treated in a belt furnace, etc (firing treatment). Each ceramic green sheet 15 is thereby sintered into a ceramic substrate 31. At the same time, the silver particles (metal particles) forming the precursors 10 are sintered, and each precursor 10 is thereby converted into a circuit (conductor pattern) 20 including a wiring pattern or an electrode pattern. As a result of such a heat treatment of the laminate 17, the laminate 17 is converted into a laminated substrate 32.

In particular, the ceramic green sheets 15 treated in this step contain a polyalcohol and also have an aqueous dispersion medium (dispersion medium) absorbed therein. Therefore, during the heat treatment in this step, the polyalcohol and the absorbed aqueous dispersion medium (dispersion medium) are gradually released into the environment. As a result, the rapid drying of the conductor pattern precursor 10 on each ceramic green sheet 15 is suppressed, whereby cracking or the like in a conductor pattern 20 formed in the step is reliably suppressed. Such an effect is more apparent when the ink 20 contains a drying retardant.

The temperature of heating the laminate 17 (firing temperature) is preferably not less than the softening point of glass contained in the ceramic green sheets 15. Specifically, the temperature is preferably 600° C. or more and 900° C. or less. The heating conditions are set to allow the temperature to increase or decrease at a suitable rate. Further, the highest heating temperature, i.e., a temperature within the range of 600° C. or more and 900° C. or less, is maintained for a suitable period of time depending on the temperature.

By increasing the heating temperature to a temperature not less than the softening point of glass, i.e., a temperature within the above range, the glass component of the resulting ceramic substrates 31 can be softened. Accordingly, when the temperature is then reduced to an ordinary temperature to harden the glass component, the ceramic substrates 31 forming the laminated substrate 32 and the circuits (conductor patterns) 20 are more firmly fixed to each other.

In particular, when the ceramic green sheets 15 are heated at a temperature of not more than 900° C., the resulting ceramic substrates 31 are low temperature co-fired ceramic (LTCC).

By the heat treatment, the metal particles forming the conductor pattern precursor 10 on each ceramic green sheet 15 are fused together to be continuous, showing electrical conductivity.

As a result of such a heat treatment, the formed circuit 20 is directly connected, and thus is electrically connected, to the contact 33 in the ceramic substrate 31. Then, when such a circuit 20 is simply placed on the ceramic substrate 31, the mechanical bonding strength between the circuit and the ceramic substrate 31 is not ensured, and a fracture may occur due to impact, etc. However, in this embodiment, as mentioned above, glass in the ceramic green sheets 15 is softened once and then hardened, and the circuits 20 are thus fixed firmly to the respective ceramic substrates 31. Accordingly, the formed circuits 20 have high mechanical strength.

In the method for producing the ceramic circuit board 30, in particular, because the conductor-pattern-forming ink 200 is applied to the ceramic green sheet 15 in the production of each of the ceramic substrates 31 forming the laminated substrate 32, a conductor pattern 20 with a desired shape can be reliably formed with high precision.

Accordingly, in the production of electronic components for electric devices, the invention not only meets the requirements of miniaturization, but also can sufficiently meet the needs for the production of small batches of a variety of products.

Moreover, because the heating temperature for the heat treatment of the ceramic green sheets 15 is not less than the softening point of glass contained in the ceramic green sheets 15, when such a ceramic green sheet 15 is heat-treated into a ceramic substrate 31, the softened glass allows the formed conductor pattern 20 to be firmly fixed on the ceramic substrate 31 (ceramic green sheet 15). Accordingly, the mechanical strength of the conductor patterns 20 can be increased.

### Second Embodiment

### Ceramic Shaped Body

Next, a ceramic shaped body according to a second embodiment of the invention will be described.

Hereinafter, a ceramic shaped body of this embodiment will be described focusing on the differences from the first embodiment. Descriptions of similar components will be omitted.

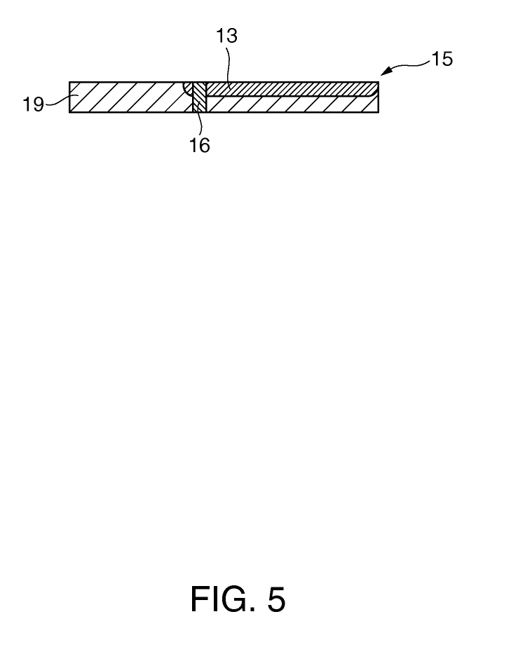

FIG. 5 shows a cross-sectional view of a ceramic shaped body according to the second embodiment of the invention. The ceramic shaped body (ceramic green sheet) 15 of this embodiment as a whole is made of a material containing a ceramic material and a binder. The ceramic shaped body 15 includes a polyalcohol-containing portion 13, which is located in a near-surface region thereof and contains a polyalcohol, and a polyalcohol-non-containing portion 19, which contains no polyalcohol. That is, in this embodiment, the polyalcohol is selectively located in a near-surface region of the ceramic shaped body 15. When the ceramic shaped body 15 contains a polyalcohol only in a near-surface region thereof, the amount of polyalcohol to be used for the production of the ceramic shaped body 15 can be suppressed. As a result, the production cost for a wiring board can be suppressed. Further, for example, when the polyalcohol-containing portion 13 containing a polyalcohol is selectively provided in the region where a conductor pattern 20 is to be formed, the excessive wet spreading of the conductor-pattern-forming ink 200 on the ceramic shaped body 15, for example, can be suppressed, and a wire with a smaller line width, for example, can be more suitably formed. This is presumably because in the ceramic shaped body 15, the polyalcohol-containing portion 13 has higher affinity (lyophilicity) to the conductor-pattern-forming ink 200 than the other region (polyalcohol-non-containing portion 19). Such a ceramic shaped body 15 can be suitably produced, as described below in detail, by applying a composition containing a polyalcohol to a sheet-like temporary shaped body 14 obtained by shaping a composition containing a ceramic material and a binder.

### Method for Producing Ceramic Shaped Body and Method for Producing Wiring Board

Next, a method for producing a ceramic shaped body 15 of this embodiment and a method for producing a wiring board (ceramic circuit board) using the ceramic shaped body 15 will be described.

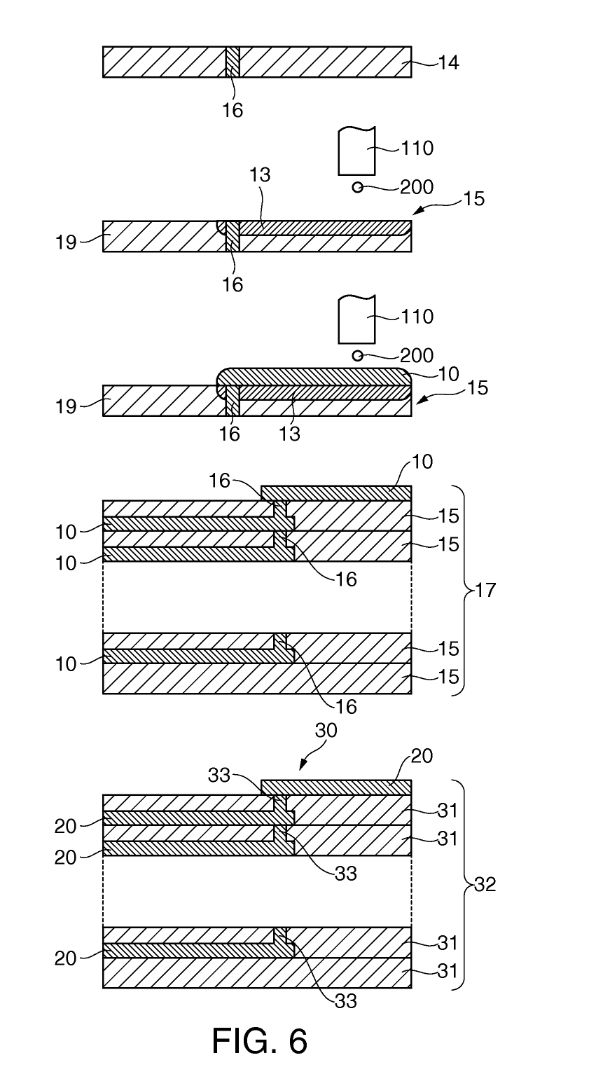

FIG. 6 shows cross-sectional views illustrating a preferred embodiment of the method for producing a ceramic shaped body according to this embodiment and a preferred embodiment of the method for producing a wiring board (ceramic circuit board) using the ceramic shaped body.

Hereinafter, production methods will also be described focusing on the differences from the first embodiment. Descriptions of similar components will be omitted.

As shown in FIG. 6, a ceramic shaped body of this embodiment is obtained through the steps of: preparing a plurality of sheet-like temporary shaped bodies 14 obtained by shaping a composition containing a ceramic material and a binder (temporary-shaped-body-preparing step); and applying a composition containing a polyalcohol to the temporary shaped bodies 14 to give ceramic shaped bodies 15 (polyalcohol-applying step). Further, a wiring board 30 is obtained through the steps of: ejecting a conductor-pattern-forming ink 200 including metal particles and a dispersion medium in which the metal particles are dispersed onto the surface of at least one of the ceramic shaped bodies 15 by a droplet ejection method, thereby forming conductor pattern precursor 10 (conductor-pattern-precursor-forming step); stacking the plurality of ceramic shaped bodies 15 to give a laminate 17 (stacking step); and heating the laminate 17 to give a wiring board 30 including a conductor pattern 20 and ceramic substrates 31 (firing step). That is, although a ceramic shaped body 15 in the first embodiment is obtained by shaping a composition containing a ceramic material, a binder, and a polyalcohol, a ceramic shaped body 15 in this embodiment is obtained by applying a composition containing a polyalcohol to a temporary shaped body 14 made of a ceramic material and a binder. By forming the ceramic shaped body 15 in this manner, the composition containing a polyalcohol can be selectively applied only to a portion of the surface of the temporary shaped body 14; for example, it is applied to the region where a conductor pattern 20 is to be formed. Accordingly, a region with a high polyalcohol content can be selectively formed in a specific area (near-surface region) of the ceramic shaped body 15. As a result, the amount of polyalcohol to be used can be suppressed, and the production cost for a wiring board can thus be suppressed. In addition, the excessive wet spreading of the conductor-pattern-forming ink 200 on the ceramic shaped body 15, for example, can be suppressed, and a wire with a smaller line width, for example, can be more suitably formed. This is presumably because in the ceramic shaped body 15, the region having a polyalcohol applied thereto in the polyalcohol-applying step has higher affinity (lyophilicity) to the conductor-pattern-forming ink 200 than the other region.

### Temporary-Shaped-Body-Preparing Step

In this step, a plurality of sheet-like temporary shaped bodies 14 made of a material containing a ceramic material and a binder are prepared.

The temporary shaped bodies 14 can be produced in the same manner as in the production of ceramic shaped bodies 15 in the first embodiment, except that a polyalcohol does not have to be used as an ingredient.

### Polyalcohol-Applying Step

In this step, a composition containing a polyalcohol (polyalcohol-containing composition) is applied to at least one surface of such a temporary shaped body 14 to form a polyalcohol-containing portion 13, thereby giving a ceramic green sheet (ceramic shaped body) 15.

The polyalcohol-containing composition applied to the temporary shaped body 14 may be in the form of a liquid, solid, or gas, and, for example, may also be formed into a predetermined shape. It is preferable that the polyalcohol-containing composition is a liquid. Asa result, the polyalcohol-containing composition can easily stored, and also, the application pattern of the polyalcohol-containing composition can be easily adjusted according to the ceramic green sheet (ceramic shaped body) 15 to be formed. When the polyalcohol-containing composition is a liquid, the viscosity thereof is not limited, and is preferably 1 mPa-s or more and 15 mPa-s or less, and more preferably 4 mPa-s or more and 11 mPa-s or less. As a result, the polyalcohol-containing composition can be suitably used in the below-mentioned droplet ejection.

The following describes, as a typical example, the case where the polyalcohol-containing composition is a liquid composition (polyalcohol-containing ink).

### Polyalcohol-Containing Composition (Polyalcohol-Containing Ink)

### Polyalcohol

The polyalcohol forming the polyalcohol-containing composition (polyalcohol-containing ink) is preferably one that satisfies the same conditions as mentioned in the first embodiment.

The content of polyalcohol in the polyalcohol-containing composition (polyalcohol-containing ink) is not limited, and is preferably 8 wt % or more, and more preferably 25 wt % or more. As a result, the polyalcohol reliably penetrates into a near-surface region of the temporary shaped body 14, and the function mentioned above can be performed more effectively.

### Other Components

The polyalcool-containing composition (polyalcohol-containing ink) may also contain other components than the polyalcohol.

Examples of such components include an aqueous dispersion medium, a surface tension adjuster, and the like.

When such components (hereinafter referred to as “other components”) are present, the content of other components in the polyalcohol-containing composition (polyalcohol-containing ink) is preferably 92 wt % or less.

The polyalcohol-containing composition (polyalcohol-containing ink) may be applied to the entire surface of the temporary shaped body 14 or to a portion of the surface of the temporary shaped body 14. It is preferable that the polyalcohol-containing composition (polyalcohol-containing ink) is selectively applied to the region where the conductor-pattern-forming ink 200 is to be applied. As a result, in the ceramic shaped body 15, the region to which the composition containing a polyalcohol has been applied and the other region can be provided with different affinities (lyophilicities) to the conductor-pattern-forming ink 200. Accordingly, the excessive wet spreading of the conductor-pattern-forming ink 200 on the ceramic shaped body 15, for example, can be suppressed, and a wire with a smaller line width, for example, can be more suitably formed.

Any method can be employed to apply the polyalcohol-containing composition (polyalcohol-containing ink) to the temporary shaped body 14, and it is preferable that the application is performed by a droplet ejection method. As a result, the site selectivity in the application of the composition containing a polyalcohol can be improved, and a fine conductor pattern 20 can be more suitably formed.

When the polyalcohol-containing composition (polyalcohol-containing ink) is applied by a droplet ejection method, this step can be performed using the same ink-jet apparatus under the same conditions as in the conductor-pattern-precursor-forming step of the first embodiment.

Thus, in this embodiment, a conductor-pattern-forming ink set including the polyalcohol-containing ink described above and the conductor-pattern-forming ink described in the first embodiment is used for the formation of a conductor pattern (production of a wiring board). Accordingly, while suppressing the amount of polyalcohol to be used and also suppressing the production cost for the wiring board, a reliable wiring board including a reliable conductor pattern that is less likely to crack, break, short-circuit, etc., can be provided.

### Conductor Pattern and Wiring Board

Next, a conductor patterns and a wiring board obtained using the ceramic shaped body will be described.

A wiring board (ceramic circuit board) 30 includes a laminated substrate 32, which is obtained by stacking a large number of (e.g., about 10 to about 20) ceramic substrates 31, and a circuit 20, which is formed on the outermost layer of the laminated substrate 32, that is, on one surface of the laminated substrate 32, and has fine wires, etc.

The laminated substrate 32 includes a conductor pattern (circuit) 20 formed from a conductor pattern precursor 10 between stacked ceramic substrates 31,31.

The conductor pattern 20 is a thin-film conductor pattern formed by heating (sintering) the conductor pattern precursor 10, and includes silver particles bonded together. At least in the surface of the conductor pattern 20, the silver particles are bonded together leaving no space.

The conductor pattern 20 preferably has a specific resistance of less than 20 μΩcm, and more preferably 15 μΩcm or less. The specific resistance refers to the specific resistance after ink application, heating at 160° C., and drying. When the specific resistance is 20 μΩcm or more, such a conductor pattern 20 is difficult to use in applications that require electrical conductivity, that is, electrodes on a circuit board, etc.

The above conductor pattern 20 is applicable to components of mobile phones, PDAs, and like portable telephone devices, such as high frequency modules, interposers, MEMS (Micro Electro Mechanical Systems), acceleration sensors, surface acoustic wave devices, antennas, and special electrodes such as interdigital electrodes, and also electronic components of various measuring devices, etc.

Each ceramic substrate 31 has formed therein a contact (via) 33 connected to the circuit 20. Because of such a configuration, the circuits 20, 20 arranged one above the other are electrically connected to each other through the contact 33.

The wiring board 30 serves as an electronic component for use in various electronic devices, which is obtained by forming a circuit pattern including various wires, electrodes, and the like, a laminated ceramic condenser, a laminated inductor, an LC filter, a high frequency composite component, or the like on a substrate.

The invention has been described based on preferred embodiments. However, the invention is not limited thereto.

For example, the second embodiment has described a configuration in which a ceramic shaped body has a polyalcohol-containing area in a near-surface region thereof, and the other area does not contain a polyalcohol. However, it is also possible that a ceramic shaped body has, in a near-surface region thereof, an area having a higher polyalcohol content than the other area (high-content portion), and the other area serves as a low-content portion with a relatively lower polyalcohol content. Such a configuration has the same effect as above.

The above embodiments have described the case where, as a typical example, a colloidal solution is used as a conductor-pattern-forming ink. However, the ink does not have to be a colloidal solution.

In addition, the above embodiments have described the case where the conductor-pattern-forming ink is a dispersion of silver particles. However, particles of other materials than silver are also possible. The metal for the metal particles may be silver, copper, palladium, platinum, gold, an alloy thereof, or the like, for example. They may be used alone or in combination. When the metal particles are alloy particles, such an alloy may be an alloy made mainly of one of the above metals and also containing other metals. It may also be an alloy made of some of the above metals mixed in an arbitrary ratio. A dispersion of mixed particles (e.g., silver particles, copper particles, and palladium particles in an arbitrary ratio) in a liquid is also usable. These metals have low resistance. Also, they are stable and resistant to oxidation during a heat treatment. Therefore, the use of these metals makes it possible to form a low-resistant, stable conductor pattern.

The above embodiments have described the case where, as a typical example, the conductor-pattern-forming ink contains an aqueous dispersion medium as a dispersion medium for dispersing metal particles. However, the ink may alternatively contain, as a dispersion medium, a nonaqueous dispersion medium (oily dispersion medium) that is water and/or a liquid having lower miscibility with water (e.g., a liquid having a solubility of less than 30 g per 100 g of water at 25° C.)

Further, for example, a piezo technique is employed as a droplet ejection technique in the above embodiments. However, this is a non-limiting example, and various known techniques are applicable. For example, bubbles formed by heating an ink may be utilized to eject the ink.

### EXAMPLES

Next, specific examples of the invention will be described.

### Example 1

### [1] Preparation of Conductor-Pattern-Forming Ink

17 g of trisodium dihydrate citrate and 0.36 g of tannic acid were dissolved in 50 mL of water made alkaline with 3 mL of a 10N aqueous NaOH solution. To the obtained solution was added 3 mL of a 3.87 mol/L aqueous silver nitrate solution, and the mixture was stirred for 2 hours to give a colloidal solution. The obtained silver colloidal solution was dialyzed until an electrical conductivity of not more than 30 μS/cm and thus desalted. After dialysis, centrifugation was performed at 3000 rpm for 10 minutes to remove coarse metal colloidal particles.

To this silver colloidal solution were added triethanolamine as a drying retardant, urea, xylitol, polyglycerin as an organic binder, and Surfynol 104PG-50 (manufactured by NISSIN CHEMICAL INDUSTRY) and Olfine EXP4036 (manufactured by NISSIN CHEMICAL INDUSTRY) as surface tension adjusters. An ion exchange water for concentration control was further added thereto to give a conductor-pattern-forming ink.

### [2] Production of Ceramic Green Sheet (Ceramic Shaped Body)

First, an alumina (Al₂O₃) powder having an average particle diameter of 1.5 μm as a ceramic powder, a titanium oxide (TiO₂) powder having an average particle diameter of 1.5 μm as a ceramic powder, and a borosilicate glass powder having an average particle diameter of 1.5 μm as a glass powder were mixed to give mixed powders.

To the mixed powders were added polyvinyl butyral as a binder, 1,3-propanediol as a polyalcohol, and dibutyl phthalate as a plasticizer. The mixture was stirred into a slurry.

Next, the slurry was shaped into a sheet on a PET film using a doctor blade. The sheet was then cut into a 200 mm×200 mm square shape to give a ceramic green sheet (ceramic shaped body).

### Examples 2 to 6

Conductor-pattern-forming inks were prepared in the same manner as in Example 1, except that the kinds and amounts of materials used for the preparation of the conductor-pattern-forming inks were as shown in Table 1. Ceramic green sheets (ceramic shaped bodies) were produced in the same manner as in Example 1, except that the kinds and amounts of materials used for the production of the ceramic green sheets (ceramic shaped bodies) were as shown in Table 2.

### Example 7

### [1′] Preparation of Conductor-Pattern-Forming Ink Set

First, a conductor-pattern-forming ink was prepared in the same manner as in Example 1.

Meanwhile, 1,3-propanediol as a polyalcohol, water, and Olfine (surfactant) were mixed to give a polyalcohol-containing ink.

A conductor-pattern-forming ink set including the conductor-pattern-forming ink and the polyalcohol-containing ink was thus obtained.

### [2] Production of Ceramic Green Sheet (Ceramic Shaped Body)

### [2-1] Production of Temporary Shaped Body

First, an alumina (Al₂O₃) powder having an average particle diameter of 1.5 μm as a ceramic powder, a titanium oxide (TiO₂) powder having an average particle diameter of 1.5 μm as a ceramic powder, and a borosilicate glass powder having an average particle diameter of 1.5 μm as a glass powder were mixed to give mixed powders.

To the mixed powders were added polyvinyl butyral as a binder and dibutyl phthalate as a plasticizes. The mixture was stirred into a slurry.

Next, the slurry was shaped into a sheet on a PET film using a doctor blade. The sheet was then cut into a 200 mm×200 mm square shape to give a temporary shaped body.

### [2-2] Application of Polyalcohol-Containing Ink

First, the polyalcohol-containing ink was loaded into a droplet ejection apparatus as shown in FIG. 3 and FIG. 4. Next, droplets of the polyalcohol-containing ink were sequentially ejected from each ejection nozzle of the droplet ejection apparatus toward the temporary shaped body, thereby forming a ceramic green sheet (ceramic shaped body). The polyalcohol-containing ink was applied to the temporary shaped body in a pattern corresponding to a conductor pattern precursor to be formed using the conductor-pattern-forming ink.

### Examples 8 to 13

Conductor-pattern-forming inks were prepared in the same manner as in Example 1, except that the kinds and amounts of materials used for the preparation of the conductor-pattern-forming inks were as shown in Table 1. Polyalcohol-containing inks were prepared in the same manner as in Example 7, except that the kinds and amounts of materials used for the preparation of the polyalcohol-containing inks were as shown in Table 2. Temporary shaped bodies were produced in the same manner as in Example 7, except that the kinds and amounts of materials used for the production of the temporary shaped bodies were as shown in Table 2. Using the conductor-pattern-forming inks, polyalcohol-containing inks, and temporary shaped bodies, ceramic green sheets (ceramic shaped bodies) were produced in the same manner as in Example 7.

### Comparative Example 1

A ceramic green sheet (ceramic shaped body) was produced in the same manner as in Example 1, except that a ceramic green sheet containing no polyalcohol was used.

Table 1 shows the amount of each component of the conductor-pattern-forming inks of the examples and comparative example. Table 2 shows the amount of each component of the ceramic green sheets of Examples 1 to 6 and Comparative Example 1, the amount of each component of the temporary shaped bodies of Examples 7 to 13, and the amount of each component of the polyalcohol-containing inks of Examples 7 to 13. In the tables, TEA represents triethanolamine, MEA represents monoethanolamine, DEA represents diethanolamine, Ur represents urea, and Xyl represents xylitol. The conductor-pattern-forming inks of the examples each had a viscosity (viscosity at 25° C. measured according to JIS Z8809 using a vibrational viscometer) within a range of 4 mPa-s or more and 11 mPa-s or less. The polyalcohol-containing inks of Examples 7 to 13 each had a viscosity (viscosity at 25° C. measured according to JIS 28809 using a vibrational viscometer) within a range of 4 mPa-s or more and 11 mPa-s or less.

TABLE 1

| | | | | Organic Binder | | | | |
|---|---|---|---|---|---|---|---|---|
| | Silver | | | (Polyglycerin) | | Surface Tension | | |
| | Colloidal | | | | Weight- | Adjuster | | |
| | Particles | | | | Average | Surfynol | Olfine | Water |
| | Content | Drying Retardant | | Content | Molecular | 104PG50 | EXP4036 | Content |
| | [wt %] | Kind | Content [wt %] | [wt %] | Weight | [wt %] | [wt %] | [wt %] |
| Example 1 | 40 | TEA/Ur/Xyl | 10.0/5.0/6.0 | 9 | About 500 | 0.02 | 0.006 | 29.974 |
| Example 2 | 40 | Ur | 5.0 | — | — | 0.02 | 0.006 | 54.974 |
| Example 3 | 40 | TEA | 10.0 | — | — | 0.02 | 0.006 | 49.974 |
| Example 4 | 40 | MEA/Ur/Xyl | 10.0/5.0/6.0 | 9 | About 600 | 0.02 | 0.006 | 29.974 |
| Example 5 | 40 | DEA/Ur/Xyl | 10.0/5.0/6.0 | 9 | About 600 | 0.02 | 0.006 | 29.974 |
| Example 6 | 40 | DEA/Ur/Xyl | 10.0/5.0/6.0 | 9 | About 600 | 0.02 | 0.006 | 29.974 |
| Example 7 | 40 | TEA/Ur/Xyl | 10.0/5.0/6.0 | 9 | About 500 | 0.02 | 0.006 | 29.974 |
| Example 8 | 40 | TEA/Ur/Xyl | 5.0/5.0/6.0 | 9 | About 500 | 0.02 | 0.006 | 34.974 |
| Example 9 | 40 | TEA/Ur/Xyl | 15.0/5.0/3.0 | 9 | About 500 | 0.02 | 0.006 | 27.974 |
| Example 10 | 40 | TEA/Ur/Xyl | 20.0/5.0/1.5 | 9 | About 500 | 0.02 | 0.006 | 24.474 |
| Example 11 | 40 | TEA/Ur/Xyl | 8.0/5.0/6.0 | 9 | About 500 | 0.02 | 0.006 | 31.974 |
| Example 12 | 40 | Xyl | 6.0 | 9 | About 500 | 0.02 | 0.006 | 44.974 |
| Example 13 | 40 | TEA/Ur/Xyl | 10.0/1.0/6.0 | 9 | About 500 | 0.02 | 0.006 | 33.974 |
| Comparative | 40 | TEA/Ur/Xyl | 10.0/5.0/6.0 | 9 | About 500 | 0.02 | 0.006 | 29.974 |
| Example 1 | | | | | | | | |

TABLE 2

| | Components of Ceramic Shaped Body (Examples 1 to 6 and Comparative | | | | | | | | | | |
|---|---|---|---|---|---|---|---|---|---|---|---|
| | Example 1) and Temporary Ceramic Shaped Body (Examples 7 to 13) | | | | | | | | | | |
| | | Titanium | | Poly- | | | | Components of Polyalcohol-Containing | | | |
| | Alumina | Oxide | Glass | vinyl | | | Dibutyl | Ink | | | |
| | Powder | Powder | Powder | Butyral | Poly-alcohol | | Phthalate | Polyalcohol | | Water | Olfine |
| | Content | Content | Content | Content | | Content | Content | | Content | Content | Content |
| | [wt %] | [wt %] | [wt %] | [wt %] | Kind | [wt %] | [wt %] | Kind | [wt %] | [wt %] | [wt %] |
| Example 1 | 20.3 | 20.3 | 40.7 | 11.2 | 1,3-Propanediol | 3.4 | 4.1 | — | — | — | — |
| Example 2 | 20 | 15 | 35 | 26 | 1,3-Butylene | 0.5 | 3.5 | — | — | — | — |
| | | | | | glycol | | | | | | |
| Example 3 | 20 | 10 | 30 | 16 | Propylene | 20.5 | 3.5 | — | — | — | — |
| | | | | | glycol | | | | | | |
| Example 4 | 19.5 | 7 | 28 | 28 | Ethylene glycol | 14.0 | 3.5 | — | — | — | — |
| Example 5 | 20 | 15 | 35 | 24.5 | 1,3-Propanediol | 2.0 | 3.5 | — | — | — | — |
| Example 6 | 20 | 12 | 30 | 17.5 | 1,3-Propanediol | 17.0 | 3.5 | — | — | — | — |
| Example 7 | 20.8 | 20.8 | 41.7 | 12.5 | — | — | 4.2 | 1,3-Propanediol | 8.0 | 91.9 | 0.1 |
| Example 8 | 20 | 15 | 35 | 26.5 | — | — | 3.5 | 1,3-Propanediol | 25.0 | 74.9 | 0.1 |
| Example 9 | 20 | 15 | 35 | 26.5 | — | — | 3.5 | Propylene | 4.0 | 95.9 | 0.1 |
| | | | | | | | | glycol | | | |
| Example 10 | 20 | 15 | 35 | 26.5 | — | — | 3.5 | 1,3-Butylene | 30.0 | 69.9 | 0.1 |
| | | | | | | | | glycol | | | |
| Example 11 | 20 | 15 | 35 | 26.5 | — | — | 3.5 | Ethylene glycol | 12.0 | 87.9 | 0.1 |
| Example 12 | 20 | 15 | 35 | 26.5 | — | — | 3.5 | 1,3-Propanediol | 17.0 | 82.9 | 0.1 |
| Example 13 | 20 | 15 | 35 | 23.5 | 1,3-Propanediol | 3.0 | 3.5 | 1,3-Propanediol | 8.0 | 91.9 | 0.1 |
| Comparative | 20 | 15 | 35 | 26.5 | — | — | 3.5 | — | — | — | — |
| Example 1 | | | | | | | | | | | |

### [3] Production and Evaluation of Ceramic Circuit Board

For each of the examples and comparative example, ceramic circuit boards were produced as follows using the conductor-pattern-forming ink and ceramic green sheet (ceramic shaped body) obtained above, and evaluated.

First, each conductor-pattern-forming ink was loaded into an ink-jet apparatus as shown in FIG. 3 and FIG. 4.

Next, the temperature of the ceramic green sheet (ceramic shaped body) placed on the table of the ink-jet apparatus was raised to 60° C. and maintained. Then, droplets were sequentially ejected from each ejection nozzle in an amount of 15 ng per drop, forming 20 lines with a line width of 35 μm, a thickness of 20 μm, and a length of 10.0 cm (precursor). The intervals between the lines were 5 mm. The ceramic green sheet having the lines formed thereon was placed in a drying furnace, and dried by heating at 60° C. for 30 minutes.

Such a ceramic green sheet having the lines formed thereon was used as a first ceramic green sheet.

Next, in another ceramic green sheet, holes were made by mechanical punching, etc., at locations corresponding to the opposite ends of each of the metal wires, forming 40 100-μm-diameter through holes in total. The through holes were filled with the conductor-pattern-forming ink to form contacts (vias). Further, using the droplet ejection apparatus, the conductor-pattern-forming ink was ejected to form a 2 mm×2 mm square pattern on each contact (via) as a terminal area.

Such a ceramic green sheet having the terminal areas formed thereon was used as a second ceramic green sheet.

Next, the first ceramic green sheet was stacked under the second ceramic green sheet, and two unprocessed ceramic green sheets were further stacked as reinforcing layers. The sheets were then pressed at a temperature of 95° C. under a pressure of 250 kg/cm² for 30 minutes to give a raw laminate. For each of the examples and comparative example, 20 such raw laminates were prepared.

Next, the laminates were sintered in air using the following sintering profile. The temperature was continuously raised at temperature rise rates of 66° C./hr for about 6 hours, 10° C./hr for about 5 hours, and then 85° C./hr for about 4 hours, and after this temperature rise process, the highest temperature, 890° C.., was maintained for 30 minutes. Ceramic circuit boards were thus obtained.

After cooling, with respect to each ceramic circuit board, a circuit tester was placed between the terminal areas formed on each of the 20 conductor pattern lines to test each line for continuity. When continuity was confirmed from all the 20 conductor pattern lines, such a ceramic circuit board was evaluated as a quality product with a conductivity of 100%. The conductivity of each ceramic circuit board was determined as a quotient obtained by dividing the number of conductor pattern lines with continuity (X) by the number of formed conductor pattern lines (20) ((X/20)×100 [%]), and the sintering stability was evaluated according to the following criteria.

A: all the 20 ceramic circuit boards had a conductivity of 100%;

B: 15 or more ceramic circuit boards had a conductivity of 100%, and other ceramic circuit boards had a conductivity of 95% or more;

C: 10 to 14 ceramic circuit boards had a conductivity of 100%, and other ceramic circuit boards had a conductivity of 95% or more;

D: 5 to 9 ceramic circuit boards had a conductivity of 100%, and other ceramic circuit boards had a conductivity of 95% or more;

E: 1 to 4 ceramic circuit boards had a conductivity of 100%, and other ceramic circuit boards had a conductivity of 95% or more;

F: all the 20 ceramic circuit boards had a conductivity of 95% or more and less than 100%

G: all the 20 ceramic circuit boards had a conductivity of less than 95%

### [4] Line-Width Stability of Conductor Pattern

For each of the examples and comparative example, a conductor pattern formed using the conductor-pattern-forming ink and ceramic green sheet (ceramic shaped body) obtained above was evaluated for line width stability as follows.

On the ceramic green sheet, 5 lines (conductor pattern precursor) were drawn at intervals of 50 μm using the conductor-pattern-forming ink by a droplet ejection method to form a film. The lines were designed to have, after drawing, a line width of 100 μm, a thickness of 20 μm, and a length of 10.0 cm. The width of each line (Y gm) was measured using a laser microscope.

Subsequently, using the ceramic green sheet having the film formed thereon, an unsintered laminate was obtained by stacking under the same conditions as above.

The laminate was immersed in liquid nitrogen for 1 minute and frozen. The laminate was then ruptured by a glass cutter in the direction perpendicular to the lines and subjected to SEM observation to check the presence of a short circuit. At the same time, the line width (Z μm) was measured. The deformation of the line width of each line was determined as ((Z−Y)/Y [%]), and line-width stability was evaluated according to the following criteria

A: deformation of the most crushed wire was less than 10%;

B: deformation of the most crushed wire was less than 20%;

C: deformation of the most crushed wire was less than 40%

D: contact (short-circuit) occurred at least partially between adjacent lines

These results are shown in Table 3.

TABLE 3

| | Evaluation of Ceramic | Line-Width |
|---|---|---|
| | Circuit Board | Stability of |
| | (Continuity Reliability) | Conductor Pattern |
| Example 1 | A | B |
| Example 2 | C | C |
| Example 3 | C | A |
| Example 4 | B | B |
| Example 5 | B | B |
| Example 6 | B | A |
| Example 7 | A | B |
| Example 8 | A | A |
| Example 9 | A | C |
| Example 10 | B | A |
| Example 11 | A | B |
| Example 12 | A | A |
| Example 13 | A | A |
| Comparative | G | D |
| Example 1 | | |

As is obvious from Table 3, the ceramic circuit boards of the invention showed excellent conductivity. Further, the conductor patterns each had a high-line width stability, so the reliability thereof was particularly high. In contrast, the comparative examples did not provide satisfactory results.

The entire disclosure of Japanese Patent Application No. 2010-044742, filed Mar. 1, 2010 is expressly incorporated by reference herein.

What is claimed is:

1. A ceramic shaped body for producing a wiring board, comprising a ceramic material, a binder, and a polyalcohol, the polyalcohol being present in at least a near-surface region of the ceramic shaped body.

2. A ceramic shaped body according to claim 1, wherein the ceramic shaped body is obtained by shaping a composition containing the ceramic material, the binder, and the polyalcohol.

3. A ceramic shaped body according to claim 1, wherein the ceramic shaped body is obtained by applying a composition containing the polyalcohol to a temporary shaped body obtained by shaping a composition containing the ceramic material and the binder.

4. A ceramic shaped body according to claim 1, wherein the polyalcohol is selectively present only in a near-surface region of the ceramic shaped body.

5. A ceramic shaped body according to claim 1, wherein the polyalcohol is 1,3-propanediol.

6. A ceramic shaped body according to claim 1, wherein the binder is polyvinyl butyral.

7. A wiring board obtained using a ceramic shaped body according to claim 1.

8. A wiring board according to claim 7, obtained using a conductor-pattern-forming ink containing a polyglycerin compound.

9. A wiring board according to claim 7, obtained using a conductor-pattern-forming ink containing an aqueous dispersion medium.
